(19) United States
(12) Patent Application Publication
(10) Pub. No.: US 2024/0306270 A1
(43) Pub. Date: Sep. 12, 2024

(54) METHOD FOR DETERMINING IDENTITY OF CONTAINER IN ELECTRIC RANGE AND ELECTRIC RANGE FOR PERFORMING SAME

(71) Applicant: COWAY CO., LTD., Gongju-si (KR)

(72) Inventors: Young Kook KIM, Seoul (KR); Yeon Soo SEONG, Seoul (KR); Young Min KIM, Seoul (KR); Sang Il CHOI, Seoul (KR); Dong Hyun KIM, Seoul (KR); Eui Soon LEE, Seoul (KR); Jun Sang PARK, Seoul (KR); Jae Ho LEE, Seoul (KR)

(73) Assignee: COWAY CO., LTD., Gongju-si (KR)

(21) Appl. No.: 18/665,757

(22) Filed: May 16, 2024

Related U.S. Application Data
(63) Continuation of application No. PCT/KR2022/017498, filed on Nov. 9, 2022.

(30) Foreign Application Priority Data
Nov. 23, 2021 (KR) 10-2021-0162040

(51) Int. Cl. H05B 6/12; G01V 3/10

(52) U.S. Cl. CPC H05B 6/1272; G01V 3/10; H05B 2213/05; H05B 2213/07

(57) ABSTRACT

A method includes: sensing a first container on an electric range by using at least one loop coil; sensing removal of the first container by using at least one of working coils; sensing a second container on the electric range by using at least one of loop coils; and determining an identity of the first container and the second container. The determining the identity is on the basis of at least one of: a first similarity determined based on damping vibration in each of at least one loop coil having sensed the first container and damping vibration in each of at least one loop coil having sensed the second container; and a second similarity determined based on the number of loop coils having sensed the first container and the number of loop coils having sensed the second container.

### TECHNICAL FIELD

The present disclosure relates to a method for determining the identity of a container to be heated in an electric range and an electric range for performing the method.

### BACKGROUND ART

An electric range is a cooking appliance that cooks food using an electric heater or a separate burner as a heat source, and is classified into an induction heater which uses induction heating and a radiant heater which uses electric resistance according to the method of heating.

As electric power is applied to the induction heater, a high-frequency voltage of a certain magnitude is applied to a working coil, generating a magnetic field around the working coil. Magnetic lines in the generated induction magnetic field generate an eddy current inside the burner, and the burner is heated by the eddy current.

In the case of the radiant heater, when a certain power is applied to a heating coil inside the burner, the heating coil emits high-temperature radiant heat by generating heat on its own, thus achieving heating.

Such an electric range usually comes with a plurality of burners, and is used as a hybrid type that allows a user to choose an appropriate burner depending on the type, amount, use, etc. of food cooked, by differently setting the output power of each burner.

Unlike traditional gas ranges, electric ranges pose no risk of explosion, are easy to use, do not produce soot caused by incomplete combustion of gas, and have a flat cooktop covering the heating elements, offering an advantage in terms of aesthetics and therefore attracting more and more users.

Meanwhile, as opposed to those providing a heating function only to a certain burner, there are electric ranges that were recently introduced that provide a heating function all over the cooktop except some area where a controller or the like is positioned. Such an electric range is called a full-free electric range.

Full-free electric ranges offer the convenience of freely changing the position of a container for cooking. A problem with full-free electric ranges is that, if the position of a container is changed during an automatic cooking operation like rice cooking, the automatic cooking operation can be canceled or an error can occur.

### Prior Art Document

(Patent Document 1) Korean Laid-Open Patent Publication No. 10-2020-0141224 (filed on Dec. 18, 2020).

### DETAILED DESCRIPTION OF INVENTION

### Technical Problems

The problem to be solved by the present disclosure is to determine the identity of a container placed on a cooktop of an electric range when the position of the container is changed, and to use the same cooking method if the container placed in a new position is identified as the same container that was in the original position, thereby improving user convenience and applying this to various additional operations such as an automatic cooking operation.

However, the problem to be solved by the present disclosure is not limited to the mentioned above, and other problems to be solved that are not mentioned will be apparent to a person having ordinary skill in the art from the following description.

### Technical Solution

In accordance with an embodiment of the present disclosure, there is provided a method for determining the identity of a container in an electric range including a plurality of working coils for inductively heating a container and a plurality of loop coils disposed to correspond to at least some of the plurality of working coils to sense the container, the method including: sensing a first container on the electric range by using at least one loop coil; sensing removal of the first container by using at least one of the plurality of working coils; sensing a second container on the electric range by using at least one of the plurality of loop coils; and determining an identity of the first container and the second container, wherein the determining the identity is on the basis of at least one of: a first similarity determined based on damping vibration in each of at least one loop coil having sensed the first container and damping vibration in each of at least one loop coil having sensed the second container; and a second similarity determined based on the number of loop coils having sensed the first container and the number of loop coils having sensed the second container.

The first similarity may be a similarity between the number of damping vibrations counted in each of the at least one loop coil having sensed the first container and the number of damping vibrations counted in each of the at least one loop coil having sensed the second container, and, in the determining the identity, the first container and the second container may be determined to be identical when the first similarity is equal to or greater than a predetermined first reference value.

The second similarity may be a similarity between the number of loop coils having sensed the first container and the number of loop coils having sensed the second container, and, in the determining the identity, the first container and the second container may be determined to be identical when the second similarity is equal to or greater than a predetermined second reference value.

In the determining the identity, the identity of the first container and the second container may be further determined on the basis of a third similarity determined based on a first temperature measured by each of at least one temperature sensor corresponding to the at least one loop coil having sensed the first container and a second temperature measured by each of at least one temperature sensor corresponding to the at least one loop coil having sensed the second container.

The third similarity may be a similarity between the first temperature and the second temperature, and, in the determining the identity, the first container and the second container may be determined to be identical when a difference between the first temperature and the second temperature is equal to or greater than a predetermined third reference value.

In the determining the identity, the identity of the first container and the second container may be further determined to be identical on the basis of a fourth similarity determined based on a first output from each of the working coils corresponding to the at least one loop coil having sensed the first container and a second output from each of the working coils corresponding to the at least one loop coil having sensed the second container, among the plurality of working coils.

The fourth similarity may be a similarity between a pattern of the first output and a pattern of the second output, and, in the determining the identity, the first container and the second container may be determined to be identical when the fourth similarity is equal to or greater than a predetermined fourth reference value.

In accordance with another embodiment of the present disclosure, there is provided an electric range including: a plurality of working coils for providing an induced current to a container; a plurality of loop coils disposed to correspond to at least some of the plurality of working coils to sense the container; and an identity determination device for sensing a first container on the electric range by using at least one of the plurality of loop coils, sensing a second container on the electric range by using at least one of the plurality of loop coils, and determining an identity of the first container and the second container on the basis of at least one of: a first similarity determined based on damping vibration in each of the at least one loop coil having sensed the first container and damping vibration in each of the at least one loop coil having sensed the second container; and a second similarity determined based on the number of loop coils having sensed the first container and the number of loop coils having sensed the second container.

When a similarity between the number of damping vibrations counted in each of the at least one loop coil having sensed the first container and the number of damping vibrations counted in each of the at least one loop coil having sensed the second container is equal to or greater than a predetermined first reference value, the identity determination device may determine that the first container and the second container are identical.

When a similarity between the number of loop coils having sensed the first container and the number of loop coils having sensed the second container is equal to or greater than a predetermined second reference value, the identity determination device may determine that the first container and the second container are identical.

### Effect of Invention

According to an embodiment of the present disclosure, when the position of a container placed on a cooktop of an electric range is changed, the identity between the container before the position thereof is changed and the container after the position thereof is changed can be determined, and thereby the result of the identity determination can be applied to various additional operations such as an automatic cooking operation. For example, if a container is identified as identical before and after the change of position, the same cooking method can be applied before and after the change of position to improve user convenience, or, even if the position of the container is changed during a rice cooking operation, the operation can continue without cancellation or an error based on the result of the identity determination for the container.

### BRIEF DESCRIPTION OF THE DRAWING

FIG. 1 is a block diagram of an electric range according to an embodiment of the present disclosure.

FIG. 2 shows an example in which a plurality of working coils and a plurality of loop coils are disposed.

FIG. 3 is a block diagram conceptually showing functions of an identity determination program according to the embodiment of the present disclosure.

FIG. 4 shows an example in which a container on the electric range is sensed.

FIG. 5 shows another example in which the container on the electric range is sensed.

FIG. 6 is a flowchart illustrating a method of determining the identity of the container by the identity determination program according to the embodiment of the present disclosure.

### BEST MODE FOR CARRYING OUT THE INVENTION

Advantages and features of the present disclosure and methods for achieving them will be made clear from embodiments described below in detail with reference to the accompanying drawings. The present disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. The present disclosure is merely defined by the scope of the claims.

In describing embodiments of the present disclosure, a detailed description of known functions or configurations related to the present disclosure will be omitted when it is deemed that they may unnecessarily obscure the subject matter of the present disclosure. The terms as used herein are defined considering the functions in the disclosure and may be replaced with other terms according to the intention or practice of the user or operator. Therefore, the terms should be defined based on the overall disclosure.

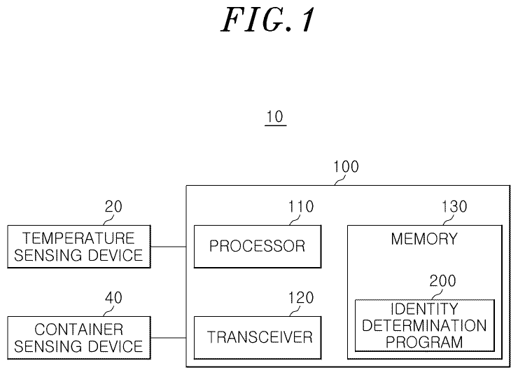

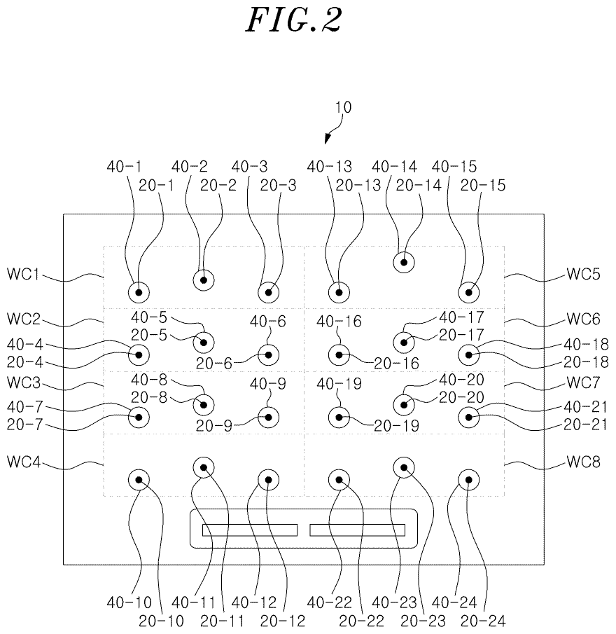

FIG. 1 is a block diagram of an electric range according to an embodiment of the present disclosure. FIG. 2 shows an example in which a plurality of working coils and a plurality of loop coils are disposed.

The electric range 10 may include a temperature sensing device 20, a container sensing device 40, and an identity determination device 100.

The temperature sensing device 20 may be provided to sense the temperature of a container placed on the electric range 10, and the container sensing device 40 may be provided to sense the container placed on the electric range 10.

In some embodiments, the electric range 10 may be a full-free electric range. Unlike conventional electric ranges in which burners are present in some part of the cooktop, and a container can be placed only at fixed positions, the full-free electric range is a type of electric range in which the entire cooktop of the electric range can work as a burner. This full-free electric range may refer to an electric range capable of sensing a container and heating the sensed container, no matter where on the cooktop the container is placed.

In some embodiments, the container sensing device 40 may include a plurality of loop coils, and may sense where on the cooktop of the electric range 10 a container is placed, by using the plurality of loop coils. That is, if the electric range 10 is a full-free electric range, the container sensing device 40 may include a plurality of loop coils so as to sense a container no matter where on the cooktop of the electric range 10 the container is placed, and may sense where on the electric range 10 the container is placed, by using at least some of the plurality of loop coils. For example, FIG. 2 exemplifies that the container sensing device 40 includes twenty-four loop coils 40-1 to 40-24.

For example, if the electric range 10 is turned on, the container sensing device 40 may apply an electrical current simultaneously or sequentially to the plurality of loop coils, and if the number of damping oscillations in some of the loop coils, caused by the applied electric current, is equal to or greater than a predetermined reference value, it may be determined that the container is positioned over those loop coils.

To this end, the plurality of loop coils may or may not be arranged at equal intervals under the cooktop of the electric range 10.

Moreover, the temperature sensing device 20 may include a plurality of temperature sensors corresponding one-to-one with the plurality of loop coils included in the container sensing device 40. For example, FIG. 2 exemplifies that the temperature sensing device 20 includes twenty-four temperature sensors 20-1 to 20-24.

The electric range 10 includes a container heating device WC capable of heating a container sensed by the container sensing device 40. The container heating device WC may include a plurality of working coils WC1 to WC8 in order to heat a portion of the cooktop of the electric range 10 where a container is placed. To this end, the plurality of working coils WC1 to WC8 may or may not be arranged in areas into which a portion of the cooktop of the electric range 10 where a container can be placed is equally divided.

In some embodiments, each of the plurality of loop coils may correspond to one of the plurality of working coils WC1 to WC8. That is, if the container sensing device 40 senses a container by using some of the plurality of loop coils WC1 to WC8, the container heating device WC may heat the container by using some of the working coils WC1 to WC8 corresponding to those loop coils.

For example, the temperature sensing device 20 may include twenty-four temperature sensors 20-1 to 20-24, the container sensing device 40 may include twenty-four loop cols 40-1 to 40-24, and the container heating device WC may include eight working coils WC1 to WC8. In this case, each of the twenty-four temperature sensors 20-1 to 20-24 and/or the loop coils 20-1 to 20-24 may correspond to one of the eight working coils WC1 to WC8.

That is, the first loop coil 40-1, the second loop coil 40-2, and the third loop coil 40-3 may correspond to the first working coil WC1, the fourth loop coil 40-4, the fifth lop coil 40-5, and the sixth loop coil 40-6 may correspond to the second working coil WC2, the seventh loop coil 40-7, the eighth loop coil 40-8, and the ninth loop coil 40-9 may correspond to the third working coil WC3, the tenth loop coil 40-10, the eleventh loop coil 40-11, and the twelfth loop coil 40-12 may correspond to the fourth working coil WC4, the thirteenth loop coil 40-13, the fourteenth loop coil 40-14, and the fifteenth loop coil 40-15 may correspond to the fifth working coil WC5, the sixteenth loop coil 40-16, the seventeenth loop coil 40-17, and the eighteenth loop coil 40-18 may correspond to the sixth working coil WC6, the nineteenth loop coil 40-19, the twentieth loop coil 40-20, and the twenty-first loop coil 40-21 may correspond to the seventh working coil WC7, and the twenty-second loop coil 40-22, the twenty-third loop coil 40-23, and the twenty-fourth loop coil 40-24 may correspond to the eighth working coil WC8.

Accordingly, if the first loop coil 40-1, the second loop coil 40-2, the fourth loop coil 40-4, and the fifth loop coil 40-5 sense a container on the electric range 10, the container heating device 40 may heat the container by controlling the output of the first working coil WC1 corresponding to the first loop coil 40-1 and the second loop coil 40-2 and the output of the second working coil WC2 corresponding to the fourth loop coil 40-4 and the fifth loop coil 40-5.

In the present specification, for convenience of explanation, the container sensing device 40 is illustrated as sensing a container by using a plurality of loop coils, and the container heating device WC is illustrated as heating a container by using a plurality of working coils, but they are not limited thereto. That is, in some embodiments, the electric range 10 may further include at least one processor (not shown), and the at least one processor (not shown) may sense a container on the electric range 10 by controlling the container sensing device 40 and heat the sensed container by controlling the container heating device WC.

The identity determination device 100 senses a container on the electric range 10 for the first time by using the plurality of loop coils included in the container sensing device 40, heats the container by using a working coil corresponding to at least one loop coil that has sensed the container, and senses removal of the container if the value of an electric current flowing through the working coil drops to below a reference value during heating of the container. Further, the identity determination device 100 senses a container on the electric range 10 for the second time by using the plurality of loop coils, and determines whether the first sensed container and the second sensed container are identical, on the basis of at least one of: a first similarity determined based on damping vibration in each of the at least one loop coil having sensed a container during the first sensing of a container and damping vibration in each of the at least one loop coil having sensed a container during the second sensing of a container, and a second similarity determined based on the number of loop coils having sensed a container during the first sensing of a container and the number of loop coils having sensed a container during the second sensing of a container.

The identity determination device 100 may include a processor 110, a transceiver 120, and a memory 130.

The processor 110 may control the overall operation of the identity determination device 100.

The processor 110 may receive temperature values of the plurality of temperature sensors from the temperature sensing device 20 and receive the number of damping vibrations in each of the plurality of loop coils from the container sensing device 40, by using the transceiver 120. In addition, the processor 110 may receive the output of each of the plurality of working coils from the container heating device WC.

The memory 130 may store an identity determination program 200 and information required to run the identity determination program 200.

In the present specification, the identity determination program 200 may refer to software including instructions programmed to determine whether containers sensed multiple times through the container sensing device 40 are identical.

The processor 110 may load the identity determination program 200 and the information required to run the identity determination program 200 from the memory 130, in order to run the identity determination program 200.

The processor 110 may run the identity determination program 200 to sense a container on the electric range 10 by using at least some of the plurality of loop coils included in the container sensing device 40.

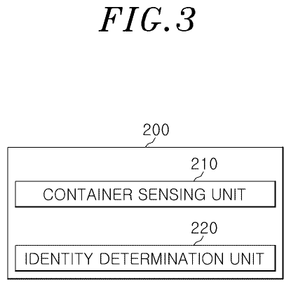

Functions and/or operation of the identity determination program 200 will be described in detail with reference to FIG. 3.

FIG. 3 is a block diagram conceptually showing functions of an identity determination program according to the embodiment of the present disclosure.

Referring to FIGS. 1, 2, and 3, the identity determination program 200 may include a container sensing unit 210 and an identity determination unit 220.

The container sensing unit 210 and identity determination unit 220 illustrated in FIG. 3 are a conceptual division of the functionality of the identity determination program 200 to facilitate explanation of the functionality of the identity determination program 200, but they are not limited thereto. In some embodiments, the functions of the container sensing unit 210 and the identity determination unit 220 may be combined/separated, and may be implemented by a series of instructions included in one program.

The container sensing unit 210 may sense a container on the electric range 10 by using the plurality of loop coils 40-1 to 40-24 included in the container sensing device 40 or by additionally using the plurality of temperature sensors 20-1 to 20-24.

More specifically, the container sensing unit 210 may sense a first container PA1 on the electric range 10, by using the plurality of loop coils 40-1 to 40-24 as a plurality of sensing devices. Further, the container sensing unit 210 may sense removal of the first container PA1 by using the plurality of working coils WC1 to WC8. Moreover, the container sensing unit 210 may sense a second container PA2 on the electric range 10, by using the plurality of loop coils 40-1 to 40-24. Here, at least one loop coil may be identical or different, among at least one loop coil that has sensed the first container PA1 and at least one loop coil that has sensed the second container PA2. Although a first sensed container is referred to as a first container and a second sensed container as a second container, this is merely for ease of understanding, and the first container and the second container may be identical or different.

The identity determination unit 220 determines the identity of containers sensed multiple times by the container sensing unit 210. That is, it determines whether containers sensed multiple times are identical or different.

More specifically, the identity determination unit 220 determines whether the first container PA1 and the second container PA2 are identical, on the basis of at least one of: a first similarity determined based on damping vibration in each of the loop coils 40-5, 40-6, 40-8, and 40-9 having sensed the first container PA1 and damping vibration in each of the loop coils 40-17, 40-18, 40-20, and 40-21 having sensed the second container PA2 and a second similarity determined based on the number of loop coils 40-5, 40-6, 40-8, and 40-9 having sensed the first container PA1 and the number of loop coils 40-17, 40-18, 40-20, and 40-21 having sensed the second container PA2. Here, if the number of damping vibrations counted in each of the loop coils 40-5, 40-6, 40-8, and 40-9 and the number of damping vibrations counted in each of the loop coils 40-17, 40-18, 40-20, and 40-21 are equal to or greater than a predetermined first reference value, the identity determination unit 220 may determine the first similarity in a way that shows that the first container PA1 and the second container PA2 are identical. Further, the identity determination unit 220 may determine the second similarity to indicate that the first container PA1 and the second container PA2 are identical when a difference between the number of the loop coils 40-5, 40-6, 40-8, and 40-9 sensing the first container PA1 and the number of the loop coils 40-17, 40-18, 40-20, and 40-21 sensing the second container PA2 are equal to or greater than a predetermined second reference value.

Moreover, the identity determination unit 220 may determine whether the first container PA1 and the second container PA2 are identical, on the basis of a third similarity determined based on a first temperature measured by each of at least one temperature sensor 20-5, 20-6, 20-8, and 20-9 corresponding to the loop coils 40-5, 40-6, 40-8, and 40-9 having sensed the first container PA1 and a second temperature measured by each of at least one temperature sensor 20-17, 20-18, 20-20, and 20-21 corresponding to loop coils 40-17, 40-18, 40-20, and 40-21 having sensed the second container PA2. Here, if the difference between the first temperature and the second temperature is equal to or greater than a predetermined third reference value, the identity determination unit 220 may determine the third similarity to indicate that the first container PA1 and the second container PA2 are identical.

Furthermore, the identity determination unit 220 may determine whether the first container PA1 and the second container PA2 are identical, on the basis of a fourth similarity determined based on a first output from each of the working coils WC2 and WC3 corresponding to the loop coils 40-5, 40-6, 40-8, and 40-9 having sensed the first container PA1 and a second output from each of the working coils WC6 and WC7 corresponding to the loop coils 40-17, 40-18, 40-20, and 40-21 having sensed the second container PA2, among the plurality of working coils WC1 to WC8. For example, if a difference between a current value of the first output and a current value of the second output is equal to or less than a predetermined threshold current value and a difference between a switching frequency of the first output and a switching frequency of the second output is equal to or less than a predetermined threshold frequency, the identity determination unit 220 may determine the fourth similarity to indicate that the first container PA1 and the second container PA2 are identical.

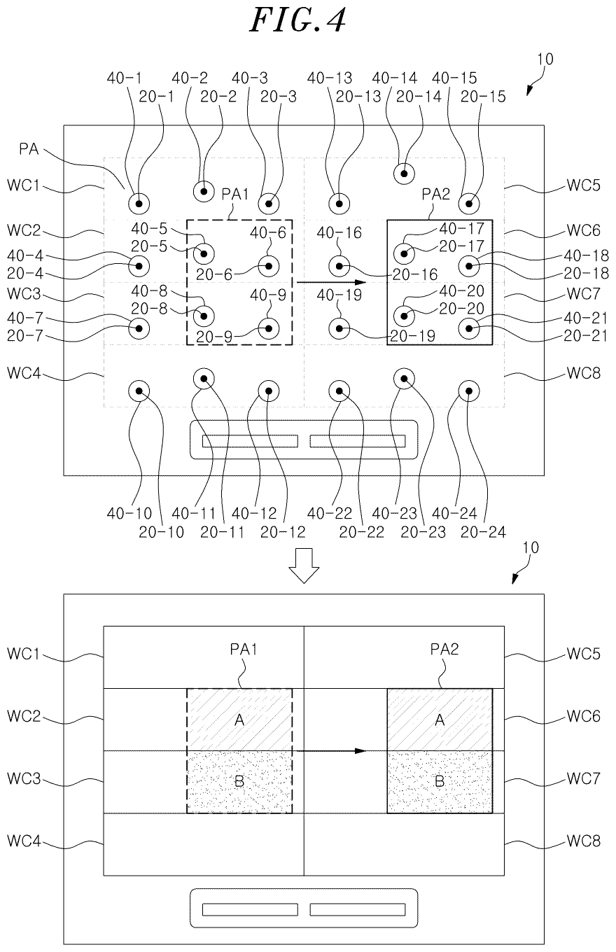

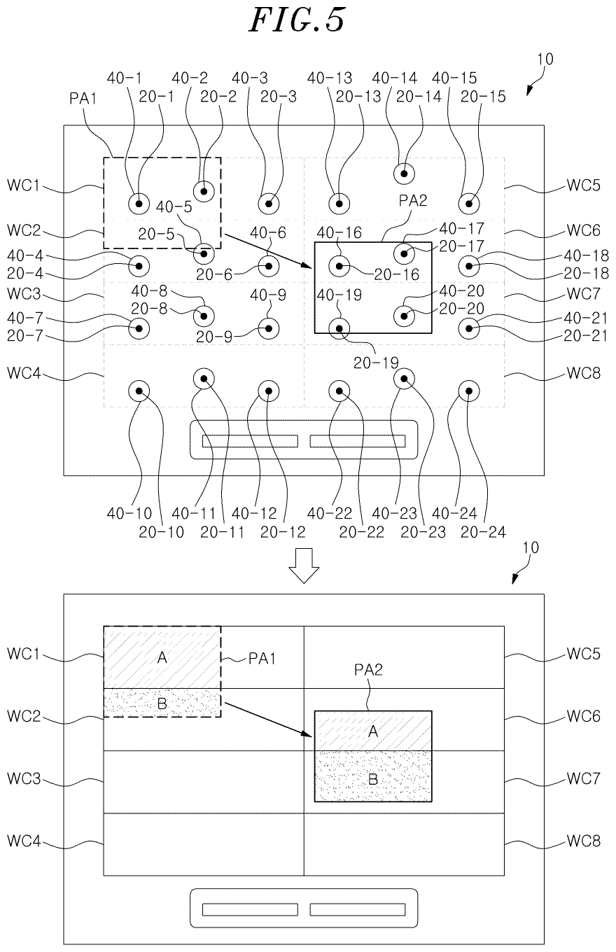

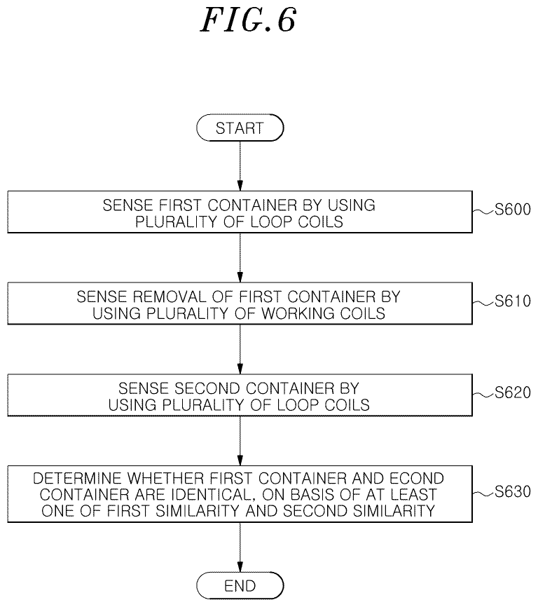

FIG. 4 shows an example in which a container on an electric range is sensed. FIG. 5 shows another example in which a container on an electric range is sensed. FIG. 6 is a flowchart illustrating a method of determining the identity of a container by an identity determination program according to the embodiment of the present disclosure. Hereinafter, a process of determining the identity of a container by considering the examples shown in FIGS. 4 and 5 will be described.

First, the temperature sensing device 20 of the electric range 10 senses the temperature of a container positioned on the electric range 10, and provides the sensed temperature information to the identity determination device 100 through the transceiver 120. Further, the container sensing device 40 of the electric range 10 senses a container positioned on the electric range 10, and provides a result of sensing the container to the identity determination device 100 through the transceiver 120. Moreover, the processor 110 of the electric range 10 may receive the output of each of the plurality of working coils WC1 to WC8 from the container heating device WC.

In this manner, in an environment in which various information is provided to the identity determination device 100, the identity determination program 200 is run by the processor 110, and a container on the cooktop of the electric range 10 is sensed, and removal of the container is sensed.

First, a first container PA1 on the electric range 10 may be sensed by using the loop coils 40-1 to 40-24 included in the container sensing device 40 (S600).

Referring further to FIG. 4, if the number of damping vibrations caused by an electric current applied to each of the fifth loop coil 40-5, the sixth loop coil 40-6, the eighth loop coil 40-8, and the ninth loop coil 40-9, among the plurality of loop coils 40-1 to 40-24, is equal to or greater than a predetermined reference value, it may be determined that the first container PA1 is positioned on the fifth loop coil 40-5, the sixth loop coil 40-6, the eighth loop coil 40-8, and the ninth loop coil 40-9. Further, since the fifth loop coil 40-5, the sixth loop coil 40-6, the eighth loop coil 40-8, and the ninth loop coil 40-9 are adjacent to one another, it may be determined that the fifth loop coil 40-5, the sixth loop coil 40-6, the eighth loop coil 40-8, and the ninth loop coil 40-9 have sensed a single container.

Moreover, if the value of an electric current flowing through the working coils WC2 and WC3 corresponding to the loop coils 40-5, 40-6, 40-8, and 40-9 having sensed the first container PA1 drops to less than a reference value, removal of the first container PA1 may be sensed (S610).

In addition, a second container PA2 on the electric range 10 may be sensed by using the plurality of loop coils 40-1 to 40-24 included in the container sensing device 40 (S620).

If the number of damping vibrations caused by an electric current applied to each of the seventeenth loop coil 40-17, the eighteenth loop coil 40-18, the twentieth loop coil 40-20, and the twenty-first loop coil 40-21, among the plurality of loop coils 40-1 to 40-24, is equal to or greater than a predetermined reference value, it may be determined that the second container PA2 is positioned on the seventeenth loop coil 40-17, the eighteenth loop coil 40-18, the twentieth loop coil 40-20, and the twenty-first loop coil 40-21. Further, since the seventeenth loop coil 40-17, the eighteenth loop coil 40-18, the twentieth loop coil 40-20, and the twenty-first loop coil 40-21 are adjacent to one another, it may be determined that the seventeenth loop coil 40-17, the eighteenth loop coil 40-18, the twentieth loop coil 40-20, and the twenty-first loop coil 40-21 have sensed a single container.

Moreover, the identity determination device 100 may determine whether the first container PA1 and the second container PA2 are identical, on the basis of at least one of: a first similarity determined based on damping vibration in each of the loop coils 40-5, 40-6, 40-8, and 40-9 and damping vibration in each of the loop coils 40-17, 40-18, 40-20, and 40-21 and a second similarity determined based on the number of loop coils 40-5, 40-6, 40-8, and 40-9 and the number of loop coils 40-17, 40-18, 40-20, and 40-21 (S630).

Referring further to FIG. 5, if the number of damping vibrations caused by an electric current applied to each of the first loop coil 40-1, the second loop coil 40-2, and the fifth loop coil 40-5, among the plurality of loop coils 40-1 to 40-24, is equal to or greater than a predetermined reference value, it may be determined that the first container PA1 is positioned on the first loop coil 40-1, the second loop coil 40-2, and the fifth loop coil 40-5. Also, since the first loop coil 40-1, the second loop coil 40-2, and the fifth loop coil 40-5 are adjacent to one another, it may be determined that the first loop coil 40-1, the second loop coil 40-2, and the fifth loop coil 40-5 have sensed a single container.

Moreover, if the value of an electric current flowing through the working coils WC1 and WC2 corresponding to the loop coils 40-1, 40-2, and 40-5 having sensed the first container PA1 drops to less than a reference value, removal of the first container PA1 may be sensed (S610).

In addition, a second container PA2 on the electric range 10 may be sensed by using the plurality of loop coils 40-1 to 40-24 included in the container sensing device 40 (S620).

If the number of damping vibrations caused by an electric current applied to each of the sixteenth loop coil 40-16, the seventeenth loop coil 40-17, the nineteenth loop coil 40-19, and the twentieth loop coil 40-20, among the plurality of loop coils 40-1 to 40-24, is equal to or greater than a predetermined reference value, it may be determined that the second container PA2 is positioned on the sixteenth loop coil 40-16, the seventeenth loop coil 40-17, the nineteenth loop coil 40-19, and the twentieth loop coil 40-20. Further, since the sixteenth loop coil 40-16, the seventeenth loop coil 40-17, the nineteenth loop coil 40-19, and the twentieth loop coil 40-20 are adjacent to one another, it may be determined that the sixteenth loop coil 40-16, the seventeenth loop coil 40-17, the nineteenth loop coil 40-19, and the twentieth loop coil 40-20 have sensed a single container.

Moreover, the identity determination device 100 may determine whether the first container PA1 and the second container PA2 are identical, on the basis of at least one of: a first similarity determined based on damping vibration in each of the loop coils 40-1, 40-2, and 40-5 and damping vibration in each of the loop coils 40-16, 40-17, 40-19, and 40-20 and a second similarity determined based on the number of loop coils 40-1, 40-2, and 40-5 and the number of 40-16, 40-17, 40-19, and 40-20 (S630).

Meanwhile, various embodiments may be used to determine the first similarity and the second similarity which are used as criteria for identity determination.

First, if the number of damping vibrations counted in each of the loop coils 40-5, 40-6, 40-8, and 40-9 and the number of damping vibrations counted in each of the loop coils 40-17, 40-18, 40-20, and 40-21 are equal to or greater than a predetermined first reference value, the first similarity may be determined to indicate that the first container PA1 and the second container PA2 are identical. Alternatively, a fourth similarity may be determined, based on a first output from each of the working coils WC2 and WC3 corresponding to the loop coils 40-5, 40-6, 40-8, and 40-9 having sensed the first container PA1 and a second output from each of the working coils WC6 and WC7 corresponding to the loop coils 40-17, 40-18, 40-20, and 40-21 having sensed the second container PA2, among the plurality of working coils WC1 to WC8. For example, if the difference between a current value of the first output and a current value of the second output is equal to or less than a predetermined threshold current value and the difference between a switching frequency of the first output and a switching frequency of the second output is equal to or less than a predetermined threshold frequency, the fourth similarity may be determined to indicate that the first container PA1 and the second container PA2 are identical.

In addition, if the difference between the number of loop coils 40-1, 40-2, and 40-5 having sensed the first container PA1 and the number of loop coils 40-17, 40-18, 40-20, and 40-21 having sensed the second container PA2 is equal to or less than a predetermined second reference value, the second similarity may be determined to indicate that the first container PA1 and the second container PA2 are identical.

Furthermore, it may be determined whether the first container PA1 and the second container PA2 are identical, on the basis of a third similarity determined based on a first temperature measured by each of at least one temperature sensor 20-5, 20-6, 20-8, and 20-9 corresponding to the loop coils 40-5, 40-6, 40-8, and 40-9 having sensed the first container PA1 and a second temperature measured by each of at least one temperature sensor 20-17, 20-18, 20-20, and 20-21 corresponding to the loop coils 40-17, 40-18, 40-20, and 40-21 having sensed the second container PA2. For example, if the difference between the first temperature and the second temperature is equal to or greater than a third reference value, the third similarity may be determined to indicate that the first container PA1 and the second container PA2 are identical.

As described above, when the position of a container placed on a cooktop of an electric range is changed, the identity between the container before the position thereof is changed and the container after the position thereof is changed can be determined, and thereby the result of the identity determination can be applied to various additional operations such as an automatic cooking operation. For example, if a container is identified as identical before and after the change of position, the same cooking method can be applied before and after the change of position to improve user convenience, or, even if the position of the container is changed during a rice cooking operation, the operation can continue without cancellation or an error based on the result of the identity determination for the container.

It will be understood that each block of a flowchart in the drawings and combinations of blocks of the flowchart may be performed by computer program instructions. These computer program instructions may be loaded into a processor of a general-purpose computer, a special-purpose computer, or other programmable data processing equipment, and thus, the instructions performed via the processor of the computer or other programmable data processing equipment create a means for performing functions specified in the flowchart block(s). The computer program instructions may also be stored in a computer-executable or computer-readable memory capable of directing the computer or other programmable data processing equipment to implement functions in a specific manner, and thus, the instructions stored in the computer-executable or computer-readable memory may produce an article of manufacture including instruction means for performing the functions described in the flowchart block(s). The computer program instructions may also be loaded into the computer or other programmable data processing equipment, and thus, instructions for operating the computer or the other programmable data processing equipment by generating a computer-executed process when a series of operations are performed in the computer or the other programmable data processing equipment may provide operations for performing the functions described in the flowchart block(s).

In addition, each block may represent a portion of a module, segment, or code that includes one or more executable instructions for executing specified logical function(s). It should also be noted that, in some alternative implementations, functions mentioned in blocks may occur out of order. For example, two blocks illustrated in succession may be executed substantially simultaneously, or the blocks may sometimes be executed in reverse order depending on functions corresponding thereto.

The above description is merely illustrative of the technical idea of the present disclosure, and those skilled in the art to which the present disclosure pertains may make various modifications and changes without departing from the essential quality of the present disclosure. Accordingly, the embodiments disclosed herein are not intended to limit the technical spirit of the present disclosure but to describe the present disclosure, and the scope of the present disclosure is not limited by these embodiments. The scope of protection of the present disclosure should be interpreted by the following claims, and all technical ideas that fall within the scope of equivalents thereof should be construed as being included in the scope of the present disclosure.

What is claimed is:

1. A method for determining the identity of a container in an electric range including a plurality of working coils for inductively heating a container and a plurality of loop coils disposed to correspond to at least some of the plurality of working coils to sense the container, the method comprising:
sensing a first container on the electric range by using at least one loop coil;
sensing removal of the first container by using at least one of the plurality of working coils;
sensing a second container on the electric range by using at least one of the plurality of loop coils; and
determining an identity of the first container and the second container,
wherein the determining the identity is on the basis of at least one of: a first similarity determined based on damping vibration in each of at least one loop coil having sensed the first container and damping vibration in each of at least one loop coil having sensed the second container; and a second similarity determined based on the number of loop coils having sensed the first container and the number of loop coils having sensed the second container.

2. The method of claim 1, wherein the first similarity is a similarity between the number of damping vibrations counted in each of the at least one loop coil having sensed the first container and the number of damping vibrations counted in each of the at least one loop coil having sensed the second container, and, in the determining the identity, the first container and the second container are determined to be identical when the first similarity is equal to or greater than a predetermined first reference value.

3. The method of claim 1, wherein the second similarity is a similarity between the number of loop coils having sensed the first container and the number of loop coils having sensed the second container, and, in the determining the identity, the first container and the second container are determined to be identical when the second similarity is equal to or greater than a predetermined second reference value.

4. The method of claim 1, wherein, in the determining the identity, the identity of the first container and the second container is further determined on the basis of a third similarity determined based on a first temperature measured by each of at least one temperature sensor corresponding to the at least one loop coil having sensed the first container and a second temperature measured by each of at least one temperature sensor corresponding to the at least one loop coil having sensed the second container.

5. The method of claim 4, wherein the third similarity is a similarity between the first temperature and the second temperature, and, in the determining the identity, the first container and the second container are determined to be identical when a difference between the first temperature and the second temperature is equal to or greater than a predetermined third reference value.

6. The method of claim 1, wherein, in the determining the identity, the identity of the first container and the second container is further determined to be identical on the basis of a fourth similarity determined based on a first output from each of the working coils corresponding to the at least one loop coil having sensed the first container and a second output from each of the working coils corresponding to the at least one loop coil having sensed the second container, among the plurality of working coils.

7. The method of claim 6, wherein the fourth similarity is a similarity between a pattern of the first output and a pattern of the second output, and, in the determining the identity, the first container and the second container are determined to be identical when the fourth similarity is equal to or greater than a predetermined fourth reference value.

8. An electric range comprising:
a plurality of working coils for providing an induced current to a container;
a plurality of loop coils disposed to correspond to at least some of the plurality of working coils to sense the container; and
an identity determination device for sensing a first container on the electric range by using at least one of the plurality of loop coils, sensing a second container on the electric range by using at least one of the plurality of loop coils, and determining an identity of the first container and the second container on the basis of at least one of: a first similarity determined based on damping vibration in each of the at least one loop coil having sensed the first container and damping vibration in each of the at least one loop coil having sensed the second container; and a second similarity determined based on the number of loop coils having sensed the first container and the number of loop coils having sensed the second container.

9. The electric range of claim 8, wherein, when a similarity between the number of damping vibrations counted in each of the at least one loop coil having sensed the first container and the number of damping vibrations counted in each of the at least one loop coil having sensed the second container is equal to or greater than a predetermined first reference value, the identity determination device determines that the first container and the second container are identical.

10. The electric range of claim 8, wherein, when a similarity between the number of loop coils having sensed the first container and the number of loop coils having sensed the second container is equal to or greater than a predetermined second reference value, the identity determination device determines that the first container and the second container are identical.
